(19) United States
(12) Patent Application Publication
(10) Pub. No.: US 2004/0170855 A1
(43) Pub. Date: Sep. 2, 2004

(54) Decorative film-like material and decorative sheet

(76) Inventor: Shigeo Kawabata, Osaka-shi (JP)

Correspondence Address: Parker & DeStefano, Suite 300, 300 Preston Avenue, Charlottesville, VA, 22902, US

(21) Appl. No.: 10/377,082

(22) Filed: Feb. 27, 2003

(51) Int. Cl. B32B 27/00

(52) U.S. Cl. 428/520; 428/500; 428/41.8

(57) ABSTRACT

A decorative film-like material prepared by a transcription printing of the present invention is capable of providing a decorative film-like material with little release between layers as well as with excellent durability. A decorative film-like material of the present invention is composed of a primer layer and a resin layer cured by heat or radiation formed on by curing after coating on the primer layer and has a cross linked resin between a primer layer and a bond/an adhesive, which is a cross linked material between layers in which a molecular chain of a resin and a cross linking agent react together.

### BACKGROUND OF THE INVENTION

1. Field of the Invention

The present invention relates to a decorative film-like material and decorative sheetnd automobile parts decorated thereby which can be used for construction components including exterior walls, street doors and exteriors and interiors of vehicles and vessels, billboards and signs.

2. Description of Related Art

For example, in order to improve design for construction components including exterior walls, street doors and exteriors and interiors of vehicles and vessels, billboards and signs, sometimes decorative sheets with some dressing like coloring are applied or dressed decorative film-like materials are bonded to a substrate.

Heretofore, as decorative film-like materials and decorative sheets excellent in design with good operational efficiency, decorative coating film-like materials with a film-like body provided which is composed of a printing layer having a releasing property to a releasing surface and a coated layer formed by a kind of resin coatings selected from the group consisting of a resin coating cured by heat, a resin coating cured by electron rays, a resin coating cured by radiation, and a resin coating cured by ultra violet rays cured after coating in such a way as to cover a surface of the printing layer have been suggested (Japanese Unexamined Laid-open Patent Publication 2001-1483).

In using this decorative film-like material, a bond is applied to a printing surface at an operational site and bonded to a substrate to which a dressing is applied or an adhesive layer is provided on a printing layer and makes it adhere to a substrate.

When a bond is applied on a printing layer or an adhesive layer is formed on a printing layer and is adhered to a substrate to which a dressing is applied by forming an adhesive layer, since a bond or a decorative layer or an adhesive layer are attached only by their affinity, in order to continuously use under harsh condition over long period of time including the use outdoors and the like, the performance had to be improved so that both layers are hard to peal off.

Therefore, further improved durability has been desired for the purpose of modifying exterior and interior of automobiles. The reason is that when these decorative film-like materials are used as a dressing for exterior parts or automobile bodies bonding or applying the decorative film-like material to automobile parts, these film-like materials are used in outdoors under harsh condition. On the other hand, when decorative film-like materials are used as interior parts, inside of an automobile is in a harsh condition in summer.

The object of the present invention is to provide a decorative film-like material and a decorative sheet in which a release between layers is hard to occur and which is excellent in durability as well as excellent in design, abrasion-resistance and solvent-resistance and to provide automobile parts and in particular, an automobile modified thereby.

### SUMMARY OF THE INVENTION

According to the first aspect of the present invention, a decorative film-like material comprises at least a decorative layer on a primer layer and a resin layer cured by heat or radiation formed by curing after coating in such a way as to cover a surface of the decorative layer, wherein the decorative film-like material has a functional group in a molecular chain of a resin used in the primer layer to which a cross linking agent reacts.

For information, radiation in the present invention means electromagnetic waves including ultra violet rays, electron rays, and particle rays.

In the present invention, a decorative film-like material preferably contains a cross linking agent.

In addition, the decorative sheet of a present invention is a decorative sheet having at least a primer layer, a resin layer cured by heat or radiation formed by curing after coating in such a way as to cover a surface of the decorative layer, an adhesive layer formed on a surface of a primer layer side and a releasing sheet which protects an adhesive layer, in which a molecular chain of a resin used for the primer layer has a functional group and between layers of the primer layer and adhesive layer, a cross linked resin cross linked by a cross linking agent is contained.

Further preferably, they are a decorative film-like material and a decorative sheet in which a functional group of a molecular chain of a resin used in the primer layer is at least either carboxyl group or hydroxyl group.

Further preferably, a resin used in the primer layer contains at least one component selected from the group consisting of polyester resin, alkyd resin, amino resin, acrylic resin, epoxy resin, and vinyl chloride resin.

Further preferably, the primer layer contains not less than 25% by weight of vinyl chloride vinyl acetate copolymer resin and acrylic resin in total amount.

Further preferably, they are a decorative film-like material and a decorative sheet in which the cross linking agent is an isocyanate cross linking agent.

Further preferably, they are a decorative film-like material and a decorative sheet in which the primer layer has a releasing property to a releasing surface transcribed by a releasing sheet for printing.

Further, they are a decorative film-like material and a decorative sheet having a metal thin film layer as a decorative layer and the like between the primer layer and a resin layer cured by heat or radiation.

In addition, the present invention relates to automobile parts modified by the decorative film-like material or a decorative sheet.

And in particular, the present invention relates to an automobile on whose surface a cosmetic coating is bonded via a bond; the cosmetic coating is composed of a decorative film-like material having at least a primer layer and a resin layer cured by heat or radiation formed by curing after coating in such a way as to cover a surface of the primer layer; and a primer layer of the cosmetic coating and the bond are united and integrated with an isocyanate cross linking agent contained in the bond reacted with a functional group of a molecular chain of a resin contained in the primer layer.

Since a decorative film-like material and a decorative sheet in the present invention are as above mentioned, the present invention is capable of providing a decorative film-like material and a decorative sheet in which a release from a substrate is hard to occur even when used for a long period of time since a primer layer and a bond or a primer layer and an adhesive layer are firmly bonded.

Further, automobile parts and an automobile excellent in design and in durability modified by these decorative film-like materials and sheets can be provided.

Other objects and the features will be apparent from the following detailed description of the present invention with reference to the attached drawings.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWING

The accompanying figures are provided by way of example, without limiting the broad scope of the invention or various other embodiments, wherein:

FIG. 1 is a sectional view showing a decorative film-like material in the first embodiment of the present invention.

FIG. 2 is a sectional view showing a decorative sheet in the first embodiment of the present invention.

FIG. 3 is a sectional view showing a decorative film-like material in the second embodiment of the present invention when a decorative layer is provided.

FIG. 4 is a sectional view showing a decorative sheet in the second embodiment of the present invention when a decorative layer is provided.

FIGS. 5(a) and (b) are sectional views showing a process flow of a production method of a decorative film-like material in the first embodiment of the present invention.

FIGS. 5(c) and (d) are sectional views showing a process flow of a production method of a decorative film-like material in the second embodiment of the present invention.

FIGS. 5(e) and (f) are sectional views showing a production process of making a decorative film-like material in the first and second embodiment of the present invention into a decorative sheet respectively.

### DETAIL DESCRIPTION OF THE PREFERRED EMBODIMENTS

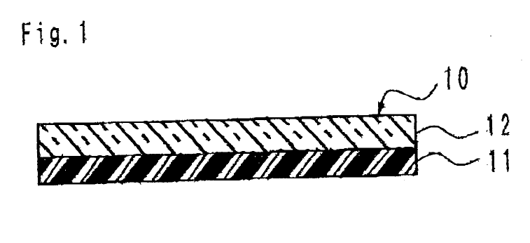

Hereinafter, a decorative film-like material and a decorative sheet in the embodiment of the present invention are explained referring to FIGS. 1 to 5.

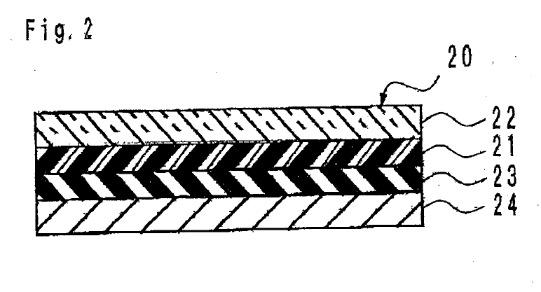

In the first embodiment of the present invention, as shown in FIG. 1, the decorative film-like material 10 has at least a primer layer 11 and a resin layer 12 cured by heat or radiation formed by curing after coating in such a way as to cover a surface of the decorative layer 12. On the other hand, as shown in FIG. 2, a decorative sheet 20 of the present invention has at least a primer layer 21 and a resin layer 22 cured by heat or radiation formed by curing after coating in such a way as to cover a surface of the primer layer, an adhesive layer 23 formed on a surface of a primer layer side, and a releasing sheet 24 which protects an adhesive layer.

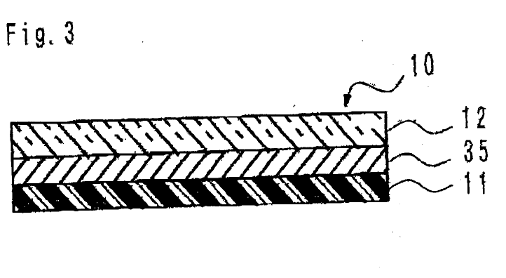

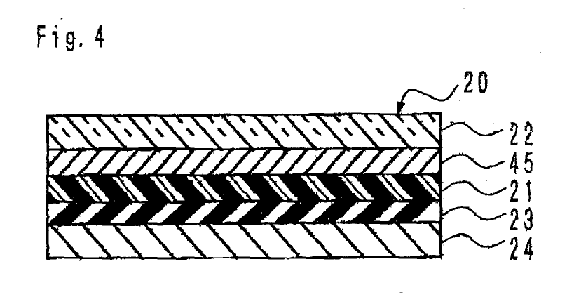

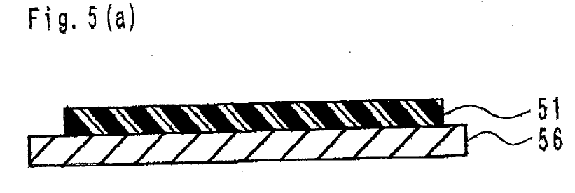

In addition, in the second embodiment of the present invention, as shown in FIGS. 3 and 4, a decorative film-like material and a decorative sheet are added to the first embodiment and decorative layers 35 and 45 are provided between resin layers 12 and 22 cured by heat or radiation.

Since a resin used in primer layers 11 and 21 achieves the property that a release between layers is hard to occur even when used for a long period of time, it is necessary to have a functional group in a molecular chain of a resin molecule which reacts to a cross linking agent. In the meantime, it is preferable that a functional group has at least either carboxyl group or hydroxyl group in view of easy reaction to a cross linking agent.

Further, chemical modification can be applied to a molecular chain of a polymer resin and such a functional group with carboxyl group or hydroxyl group introduced can be used.

As such resins, resins which are selected at least from one component containing polyester resin, alkyd resin, amino resin, acrylic resin, epoxy resin, vinyl chloride resin can be used. Further, when resins have compatibility, these resins can be mixed or can be used in a state of multi layers.

Further preferably, primer layers 11 and 21 contain a thermoplastic resin in not less than 25% by weight, and even more preferably 50% by weight which contains at least either of vinyl chloride vinyl acetate copolymer resin and acrylic resin. Vinyl chloride vinyl acetate copolymer resin to be used is not specifically limited, but it is preferable that the weight ratio of vinyl chloride/ vinyl acetate is 92/8 to 75/25, and the average molecular weight is within the range of 25000 to 45000. Acrylic resin preferably includes acrylic polyol.

For information, either of vinyl chloride vinyl acetate copolymer resin may be contained in total of 100% by weight.

Although a thickness of primer layers 11 and 21 is not specifically limited, a thickness is preferably about 0.3 ìm to 50 ìm, and more preferably, 1 ìm to 10 ìm. That is, when primer layers are too thick, flexibility of a decorative film-like material is deteriorated and in the case of a substrate having uneven surface, a decorative film-like material and a decorative sheet may not be well fitted to a substrate. On the other hand, when primer layers are too thin, a bonding property to a bond or an adhesive is not satisfactory enough to achieve the object of the present invention.

In order to produce such primer layers 11 and 21 preferably, it is preferable that a resin which composes primer layers is formed by coating on a releasing sheet 35, followed by transcribing. In this case, it is preferable that a resin which composes primer layers has releasing property to a releasing surface. The above exemplified resin also has such a property as well.

It is preferable that a cross linking agent is contained in a primer layer 11 of a decorative film-like material 10 in order to strengthen a bonding between layers. Unless a cross linking agent is contained in primer layers, it is necessary that a cross linking agent is contained in a bond. By adopting such a composition, chemical bonding can be generated between a primer layer and a bond after bonding a decorative film-like material to a substrate.

Further, since a cross linked resin is contained by a cross linking agent between layers of a primer layer 21 and an adhesive layer 23, a bonding between layers gets strong in the case of a decorative sheet 20.

Examples of such cross linking agents capable of obtaining such a property include isocyanate cross linking agents, epoxy cross linking agents, and aluminum chelate cross linking agents. These cross linking agents play a role in strengthening a bonding between layers since these cross linking agents chemically react with a functional group of resin molecules of primer layers 11 and 21 in particular, with carboxyl group or a hydroxyl group thereby contributing to having a three dimensional chemical structure over a surface of primer layers and a bond or adhesive layers. In particular, when vinyl chloride vinyl acetate copolymer resin are used for primer layers 11 and 21, using isocyanate cross linking agents which is likely to react with hydroxyl group of a resin as a cross linking agent is further preferable since chemical reaction between layers is strengthened.

In order to draw such a property, it is preferable to mix a cross linking agent in primer layers 11 and 21 or an adhesive layer 23. Conventional mixing method can be adopted. As for mixing ratio, the substantial ratio of a cross linking agent to a resin composing a primer layer or an adhesive composing an adhesive layer is preferably about 0.02% to 6%. When a ratio of a cross linking agent is too low, a bonding effect between layers is not satisfactory. On the other hand, when a ratio of a cross linking agent is too high, a bonding effect is unchanged from a certain level and therefore useless.

As for resins used for resin layers 12 and 22 cured by heat or radiation, known resins can be used as long as they are non-solvent type resins cured by heat or radiation, but light-cured olygomers having double bond including acrylic group, methacrylic group, allyl group, and vinyl group (for example, urethane acrylate resin) and monomers (for example, tripropylene glycol diacrylate) or compounds thereof are preferably used as main components.

Coloring components can be contained in resin layers 12 and 22 cured by heat or radiation. As coloring components to be used, known coloring components can be used as exemplified in an explanation of a decorative layer mentioned hereinafter.

Further, as required, ultra violet ray absorbent, other light stabilizer, anti-oxidant, anti-aging agent, leveling agent, anti-static agent, fixing agent, plasticizer, lubricant, organic filler, inorganic filler, such metal (compound) oxide fine particles as titanium oxide, zinc oxide, ITO and the like having ultra violet ray absorption power or near-infrared ray absorption power can be added as additives in a resin layer cured by heat or radiation.

In addition, resin layers 12 and 22 cured by heat or radiation can be composed of multiple layers. In this case, different coloring components can be contained respectively. When a resin layer cured by heat or radiation is composed of multiple layers and different coloring components are contained respectively, design can further be improved.

A thickness of resin layers 12 and 22 cured by heat or radiation is 10 ìm to 500 ìm, and preferably, 20 ìm to 300 ìm. When a thickness of resin layers 12 and 22 cured by heat or radiation is less than 10 ìm, a design is not satisfactorily shown, a decorative layer protecting effect is low when a decorative film-like material is provided which is mentioned later, and therefore, it becomes difficult to take a role as a decorative film-like material or a decorative sheet. On the other hand, when a thickness of resin layers 12 and 22 cured by heat or radiation exceeds 500 ìm, flexibility of a decorative film-like material and a decorative sheet decreases and handling becomes difficult.

Although forming methods of resin layers 12 and 22 cured by heat or radiation is not specifically limited, such methods can be exemplified that after a coating process in which a resin composition cured by heat or radiation is coated on a decorative layer surface with a specific thickness including bar coat method, roll coat method, air doctor coat method, blade coat method, squeeze coat method, air knife coat method, reverse roll coat method, gravure coat method, transfer coat method, fountain coat method, slit die coat method, or lip die coat method, and the like, followed by heating a resin composition or irradiating ultra violet rays, electron rays, radioactive rays, and the like. When a resin cured by electron ray is used as a resin, electron ray irradiation devices are not specifically limited, and for example, such electron ray irradiation devices with Van der Graaf scanning method, double scanning method, and curtain beam method can be used and among them, an electron ray irradiation device is preferable since it is relatively low in cost and radiation output of electron ray is large. Necessary acceleration voltage is selected depending on a thickness of a coated film. Atmosphere of electron ray irradiation is in inert gases containing no nitrogen burning gas, oxygen, or ozone.

In addition, acceleration voltage in electron ray irradiation is preferably 100 kV to 500 kV. In order to improve transmission rate of electron ray, acceleration voltage is preferably not less than 250 kV. Although absorption dose of electron ray is not specifically limited as long as desired cure is provided, generally, the absorption dose is 0.1 Mrad to 7 Mrad and preferably 0.2 Mrad to 5 Mrad. When absorption dose of electron ray is less than 0.1 Mrad, cure of resin composition cured by electron ray by electron ray irradiation is not satisfactory. On the other hand, when absorption dose of electron ray exceeds 7 Mrad, sometimes a seat type substrate is deteriorated or tarnished. Further, it is not preferable from a view point of energy saving.

A surface of resin layers 12 and 22 cured by heat or radiation can be covered by a metal layer and by a protection film.

In order to improve designs, such a decorative film-like material and a decorative sheet that are provided with decorative layers 35 and 45 between primer layers 11 and 21 and resin layers 12 and 22 cured by heat or radiation can be prepared. As for the specific embodiment of decorative layers 35 and 45, when a decorative layer is formed by printing, although an ink to used is not specifically limited, acrylic resin, fluoride resin, inorganic resin, and the like are exemplified. Among them, acrylic resin is preferable. As specific colorant components which can be contained, black carbon pigments such as RAVEN 420 (manufactured by Columbian Corporation), CARBON BLACK (manufactured by Degussa AG), MONARCH 1000 (manufactured by Cabot Corporation), CARBON BLACK 2400 B(Mitsubishi Chemical Corporation), and the like, blue pigments and green pigments such as HELIOGEN BLUE L-6900, HELIOGEN GREEN L-8605 (manufactured by BASF Japan Ltd), PALOMAN BLUE B-4806 (manufactured by Bayer AG), FASTGEN BLUE 5030F, FASTGEN GREEN S (manufactured by Dainippon Ink and Chemicals Incorporated ), and white pigments such as titanium oxide and pigments with other colors.

Further, with a view to improving designs, metal fine particles or glittering pigments can be added to coloring components. Moreover, coloring components can be used alone or in combinations of two or more of them. In addition, in order to provide a decorative film-like material with a plating toned design, decorative layers 35 and 45 can be a metal thin film layer prepared by a forming method of a metal thin film layer. As a general method of forming a metal thin film layer, spattering method or vapor deposition method and the like can be cited.

When metal thin film are built up in a primer layer, for example, when a spattering method is used, spattered metal is repelled and therefore is not built up. However, by containing cross linking agents such as isocyanate in a primer layer, a metal thin film can be formed. In this case, kinds of metals are not specifically limited as long as they are metals capable of forming a metal thin film by these methods. Examples of usable metals include chrome, aluminum, titanium, gold, silver, and the like. In addition, alloy can be used using several kinds of metals.

When decorative layers 35 and 45 are provided, in order to strengthen bonding between decorative layers 35 and 45 and resins 12 and 22 cured by heat or radiation, the second primer layer can be provided between decorative layers 35 and 45 and resins 12 and 22cured by heat or radiation. Although resins used in the second primer layer 16 are not specifically limited, when such resins cured by radiation which are composed of, in particular, acrylic olygomer and/or acrylic resin are used in not less than 25% by weight, decorative film-like materials or decorative sheets excellent in weather resistance, abrasion-resistance, solvent resistance, and chemical resistance with little contraction rate can be provided.

When a decorative sheet 20 of the present invention is prepared, it is necessary that an adhesive layer 23 is formed in a decorative film-like material 10 of the the composition and a releasing sheet 24 is applied for protecting the the adhesive layer. By preparing a decorative sheet having such a composition, workability at an operational site in which a decorative sheet is adhered to a substrate become easier and smooth transition from an operational site for preparing a decorative sheet to an operational site for adhering a decorative sheet is realized.

Although an adhesive which can be used for forming an adhesive layer 23 is not specifically limited, it is necessary to use an adhesive with a property of chemically bonding with a molecular chain of a resin in a primer layer 21 and it is preferable to use an adhesive excellent in weather resistance. Examples include acrylic adhesive J which contains both acrylic polymer and an adhesion imparting agent. Here, as a monomeric unit which composes an acrylic polymer of an acrylic adhesive, (meth)acrylate alkyl ester including methyl (meth)acrylate, ethyl (meth)acrylate, propyl (meth)acrylate, butyl (meth)acrylate, and the like can be exemplified.

Further, as adhesion imparting agents, such agents as rosin adhesion imparting agents, terpene adhesion imparting agents, phenol adhesion imparting agents, coumarone adhesion imparting agents, and the like can be exemplified.

A thickness of an adhesive layer 23 is preferably 30 to 100 ìm and more preferably, 35 to 80 ìm. When a thickness of an adhesive layer 12 is less than 30 ìm, it is possible that adhesive strength is not enough when a decorative sheet 10 is adhered to a substrate. On the other hand, when a thickness of an adhesive layer 12 is greater than 100 ìm, it becomes unnecessarily thick and therefore is not cost-effective.

As for a releasing sheet 24, it is not specifically limited as long as an adhesive does not bond, and examples include film type sheet such as polyethylene terephthalate, polyethylene, polypropylene, and the like, or paper type sheet such as quality paper or kraft paper and the like on which a releasing agent such as silicone and the like is coated on. A thickness of a releasing sheet is preferably 25 to 50 ìm from a view point of easy handling and cost-effectiveness.

When a decorative film-like material is used, after a bond is applied to a decorative film-like material 10 or to a substrate surface to which a decorative film-like material 10 is applied, a decorative sheet is provided in such a way as to closely contact with a substrate surface and is bonded to a substrate surface and integrated via a bond. After bonding, in order to make a cross linking agent react, a cross linking agent must be heated and/or pressurized to some degree or more.

Further, this decorative film-like material can be used as a paintless film used for blow molding method, insert molding method, film in mold method, SMC molding method, PFM molding method, and the like.

On the other hand, in the case of a decorative sheet 20, a releasing sheet 25 is peeled off and is adhered to a substrate.

(Production Method)

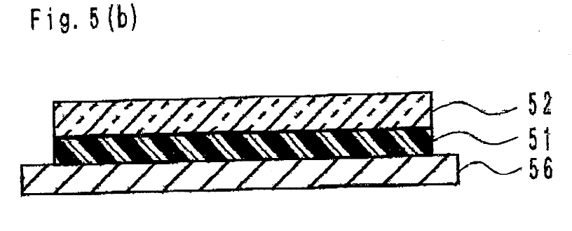

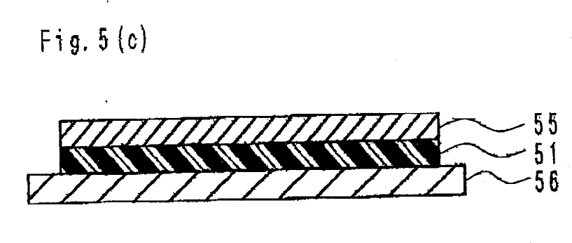

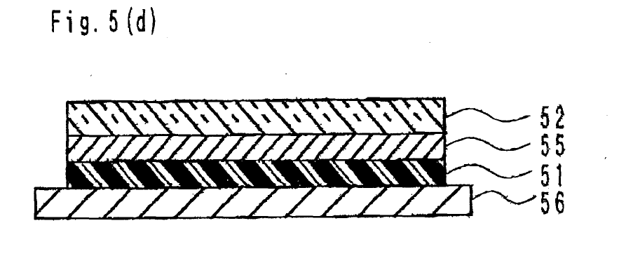

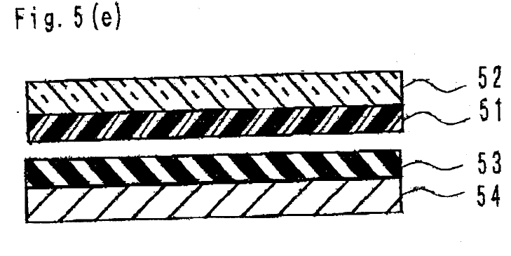

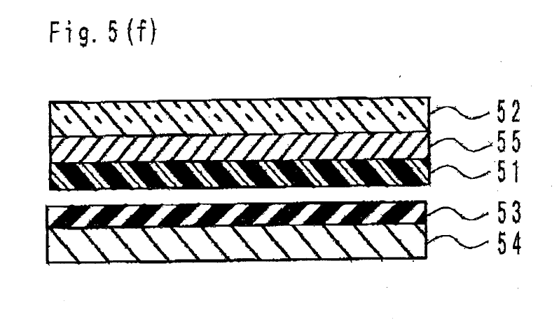

Next, a production method of decorative film-like material 10 and a decorative sheet 20 of the present invention is explained in detail referring to FIG. 5.

As shown in FIG. 5(a), the first process for producing a decorative film-like material 10 in the present invention is conducted first by printing a primer layer 51 provided with a releasing property to a releasing surface on a surface of a releasing sheet 56 for printing.

For information, when a cross linking agent is mixed with a resin used in a primer layer 51 and/or an adhesive in a forming process of an adhesive layer 53 which is stated later, a conventional method for mixture can be adopted.

Here, in order to improve design, as shown in FIG. 5(c), following the first process, an ink which contains a coloring component can further be printed and a decorative layer 55 can be provided. A decorative layer can be prepared not only by a printing method but also by a general metal thin film production method using a primer layer containing a cross linking agent depending on the case for example when a metallic luster is desired or the like. Further, in forming the second primer layer on a surface of a decorative layer, following the process, a resin component composing the second layer can be applied by printing on a surface of a decorative layer.

As shown in FIGS. 5(b) and (d), the second process is conducted by applying resins cured by heat or radiation to the substance obtained by the first process. For example, when a resin cured by an electron ray is used, the second process is conducted by applying non-solvent type resin coating 52′ cured by electron ray which composes resin layer 52 cured by heat or radiation to a layer built up in the first process.

The third process is conducted by forming a resin layer 52 cured by heating a resin or irradiating. For example, in the case of exemplified second process, a non-solvent-type resin coating 52′ cured by electron ray is put in an electron ray irradiating device in a non-cured state and by applying an electron ray irradiation, a non-solvent-type resin coating 52′ is cured.

By releasing a releasing sheet 56 for printing from the substance obtained by the above processes, a decorative film-like material 10 as shown in FIG. 1 can be obtained.

Further, in order to obtain a decorative sheet 20, as shown in FIG. 5(e) and (f), the process for forming an adhesive layer 53 on a decorative film-like material 10 is required. An adhesive layer 53 is formed by applying an adhesive to a releasing sheet, followed by applying this releasing sheet and transcribing, thereby adhering.

This state was left to stand for 3 days at a temperature of 50° and a reaction of a cross linking agent is promoted. Through such a process, a decorative sheet 20 of the present invention can be obtained.

Aforementioned decorative film-like material and decorative sheet are excellent in design, abrasion resistance, and solvent resistance, and in particular, excellent in durability. Therefore, it can be used for construction components including walls, columns, doors, and the like, for vehicles and vessels, and for billboards and signs. In particular, the decorative film-like material and decorative sheet of the present invention can preferably be used for bumpers, sash tapes for mirror parts, films for automobile display, further for a coating of automobile bodies.

### EXAMPLES

Hereinafter, the examples of the present invention are explained in detail.

### Example 1

Aromatic isocyanate as a cross linking agent (trade name: L-55 E, manufactured by Nippon Polyurethane Industry Co., Ltd) was mixed to an acrylic resin with substantial ratio of 0.85%. Then, a resin component which contains the cross linking agent was solidly printed with a thickness of 4 ìm as a primer layer on a whole surface of a releasing surface of a releasing sheet with releasing auxiliary layer provided or a surface of untreated polyester film (manufactured by Toyobo Co., Ltd) with a thickness of 32 ìm.

This sheet built up by a decorative layer was taken and a transparent non-solvent type electron ray resin coating (main component thereof is a compound of urethane acrylate resin and tripropylene glycoldiacrylate manufactured by SANYU-PAINT Co., Ltd) was applied on a decorative layer by a gravure coating method in a thickness of 75 ìm. Then, on this resin coating cured by electron rays, polyester embossed film (manufactured by Toyobo Co., Ltd) with a thickness of 32 ìm having uneven surfaces like frosted glass was provided as a protection film and was put in an electron irradiation device (manufactured by Nisshin Electrics, Ltd, curtain beam method) in a nitrogen atmosphere in a way that the the uneven surface is fitted to a resin coating cured by electron rays.

Then, 4 Mrad electron ray with an accelerated voltage of 250 kV was irradiated, and the resin coating was cured, thereby forming a curable resin layer and a decorative film-like material was obtained.

Next, in order to form an adhesive layer, an acrylic adhesive (X-0589 manufactured by VIG TEQNOS LTD) was applied to a releasing sheet of quality paper. From a decorative film-like material, a releasing sheet for printing was released. And to the exposed primer layer with a releasing sheet removed, releasing sheet of quality paper was applied in which an adhesive (X-0589 manufactured by VIG TEQNOS LTD) is molded on releasing sheet of a quality paper. Then, it was left to stand as it is for three days at a temperature of 50°, transcribed, and adhered. Through this process, a decorative sheet was obtained.

Releasing test was conducted again for an obtained decorative sheet. This test is adopted to examine the amount of a material which comprises the decorative sheets including an adhesive or the like remained on an SUS plate when an SUS plate. The procedure was as follows: An SUS plate was applied to an exposed adhesive layer with the releasing sheet removed. Next, one shuttling on a decorative sheet was applied to an SUS plate by a rubber roller with a loading of 2 kg/cm². Further, this was heated for 30 minutes with a temperature of 80°. Then, after left to stand for 24 hours at a room temperature and a decorative sheet was peeled off at a speed of 300 mm/minute in an angle of 180°.

After this test, if there remains an adhesive (paste remaining ratio), it can be the that a releasing between layers is likely to occur.

When the test for a releasing property was conducted again on a decorative board obtained in this Example, a releasing occurred between an SUS plate and an adhesive layer and the paste remaining ratio was 1%.

### Example 2

A decorative sheet was produced by the same method as in Example 1 except that aromatic isocyanate as a cross linking agent (trade name: L-55 E, manufactured by Nippon Polyurethane Industry Co., Ltd) was mixed to an acrylic resin with substantial ratio of 1%. When a releasing test was conducted by the same method as in Example 1, a releasing occurred and the paste remaining ratio was 0.1%.

### Example 3

A decorative sheet was produced by the same method as in Example 1 except that aromatic isocyanate as a cross linking agent (trade name: L-55 E, manufactured by Nippon Polyurethane Industry Co., Ltd) was mixed to an acrylic resin with substantial ratio of 2%. When a releasing test was conducted by the same method as in Example 1, a releasing occurred and the paste remaining ratio was 0%.

### Example 4

A decorative sheet was produced by the same method as in Example 1 except that aromatic isocyanate as a cross linking agent (trade name: L-55 E, manufactured by Nippon Polyurethane Industry Co., Ltd) was mixed to an acrylic resin with substantial ratio of 3%. When a releasing test was conducted by the same method as in Example 1, a releasing occurred and the paste remaining ratio was 0%. From the result of Examples 1 to 4, it was found that in a decorative paper sheet of the present invention, as the ratio of isocyanate increases, a bonding between layers gets stronger. Therefore, it can be the that the decorative sheet of the present invention is excellent in durability.

### Example 5

Acrylic resin was solidly printed with a thickness of 4 ìm as a primer layer on a whole surface of a releasing surface of a releasing sheet with releasing auxiliary layer provided or a surface of untreated polyester film (manufactured by Toyobo Co., Ltd) with a thickness of 32 ìm. Next, a grained decorative layer was printed by a gravure method with a thickness of 4 ìm using acrylic resin layer. This sheet built up by a primer layer and a decorative layer was taken and a transparent non-solvent type electron ray resin coating (main component thereof is a compound of urethane acrylate resin and tripropylene glycoldiacrylate manufactured by SANYU-PAINT Co., Ltd) was applied on a decorative layer by a gravure coating method in a thickness of 75 ìm.

This was cured by a curing method shown in Example 1. Next, aromatic isocyanate as a cross linking agent (trade name: L-55 E, manufactured by Nippon Polyurethane Industry Co., Ltd) was mixed to an acrylic adhesive (X-0589 manufactured by VIG TEQNOS LTD) with a substantial rate of 2%. An adhesive layer was prepared in the same process as shown in Example 1. When the test for a releasing property was conducted again on an obtained decorative sheet, a releasing occurred between an SUS plate and an adhesive layer and the paste remaining ratio was 0%. In addition, flaws such as wrinkling, cracking, and the like could not be seen in a grained design. From this result, it can be the that in a decorative paper sheet in the present invention, the problem of a releasing is hard to occur and the decorative sheet of the present invention is excellent in durability.

### Example 6

Aromatic isocyanate as a cross linking agent (trade name: L-55 E, manufactured by Nippon Polyurethane Industry Co., Ltd) was mixed to an acrylic adhesive (X-0589 manufactured by VIG TEQNOS LTD) with a substantial rate of 1%. A resin component was solidly printed with a thickness of 10 ìm as a primer layer on a whole surface of a releasing surface of a releasing sheet with releasing auxiliary layer provided or a surface of untreated polyester film (manufactured by Toyobo Co., Ltd) with a thickness of 32 ìm. Next, this sheet was put in a spattering device and silver was built up with a thickness of 1 ìm on this primer layer by a spattering method, thereby preparing a decorative layer. This sheet with a decorative layer built up was taken and a transparent non-solvent type electron ray resin coating (main component thereof is a compound of urethane acrylate resin and tripropylene glycoldiacrylate manufactured by SANYU-PAINT Co., Ltd) was applied on a decorative layer by a gravure coating method in a thickness of 75 ìm. Then, a releasing sheet for printing of a decorative film-like material was peeled off and an acrylic resin bond was applied to an exposed primer layer and was bonded on a surface of SUS plate via a bond and using a roll press in a state of 40° and pressurizing 1.6 kg/cm², thereby obtaining a decorative board.

The obtained decorative board had a finish with plating tone. When a repeated releasing test was conducted by the same method as shown in Example 1, a releasing occurred between an SUS plate and an adhesive and the paste remaining ratio was 3%. However, this is assumed to be a result that a bonding force was stronger than an adhesive force. Therefore, it can be the that the decorative board is excellent in durability in which release between layers and the like are hard to occur.

### Comparative Example 1

A decorative sheet was obtained by the same process as in Example 1 except for the mixture of an isocyanate, a cross linking agent. When a releasing test was conducted again, a breakage occurred and the paste remaining ratio was 8%. From this result, compared with a decorative sheet of the present invention, a decorative sheet of Comparative Example 1 is more likely to cause release between layers.

### Comparative Example 2

A decorative sheet was obtained by the same process as in Example 5 except for the mixture of an isocyanate, a cross linking agent. When a releasing test was conducted again, a breakage occurred and the paste remaining ratio was 12%. Some wrinkles were observed in a grained design. From this result, compared with a decorative sheet of the present invention, a decorative sheet of Comparative Example 2 is more likely to cause release between layers.

### Comparative Example 3

A decorative film-like material was tried to be obtained by the same process as in Example 6 except for the mixture of an isocyanate, a cross linking agent. However, a silver was not built up in a spattering process and a decorative film-like material could not be obtained.

### Comparative Example 4

Since it was found that a silver was not built up in Comparative Example 3, a resin cured by an electron ray in the Example 6 was coated without building up a silver. Then, a decorative board was obtained by the same method as in Example 6. When a releasing test was conducted on this decorative board, a breakage occurred inside of a primer layer and the paste remaining ratio was not less than 50%. From this result, it was inferred that decorative film-like materials of Comparative Examples are more likely to cause release between layers than a decorative film-like material of the present invention.

As above mentioned, since a strong chemical bonding occurs in a decorative film-like material over a surface between a primer layer and a bond or an adhesive, a decorative film-like material and a decorative sheet can be obtained in which a releasing from a substrate is hard to occur even when used for a long period of time.

Therefore, a decorative film-like material and decorative sheet of the present invention can be used for construction components including walls, columns, doors and the like, for vehicles and vessels, for billboards and signs. Among them, a decorative film-like material and decorative sheet of the present invention can preferably be used for modified automobile parts or modified automobiles including exteriors including automobile bodies and the like, bumpers, automobile interior displays including mirrors and the like, in which a good performance under harsh condition is required.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a)“means for” or “step for” is expressly recited; b) a corresponding function is expressly recited; and c) structure, material or acts that support that structure are not recited.

What is claimed is:

1. A decorative film-like material having at least a decorative layer on a primer layer and a resin layer cured by heat or radiation formed by curing after coating in such a way as to cover a surface of the decorative layer, wherein the decorative film-like material has a functional group in a molecular chain of a resin used in the primer layer to which a cross linking agent reacts.

2. The decorative film-like material as set forth in claim 1, wherein a cross linking agent is contained in the primer layer.

3. The decorative film-like material as set forth in claim 1, wherein an isocyanate cross linking agent is contained in the primer layer.

4. The decorative film-like material as set forth in claim 1, wherein a functional group of a molecular chain of a resin used in the primer layer is at least either carboxyl group or hydroxyl group.

5. The decorative film-like material as set forth in claim 4, wherein a resin used in the primer layer contains at least one component selected form the group consisting of polyester resin, alkyl resin, amino resin, acrylic resin, epoxy resin, and vinyl chloride resin.

6. The decorative film-like material as set forth in claim 5, wherein the primer layer contains vinyl chloride vinyl acetate copolymer resin or acrylic resin in a total of not less than 25% by weight.

7. The decorative film-like material as set forth in claim 6, having a metal thin film layer including the use as a decorative layer between the primer layer and a resin layer cured by heat or radiation.

8. The decorative layer as set forth in claim 6, wherein the primer layer has a releasing property to a releasing surface transcribed by a releasing sheet for printing.

9. The decorative film-like material as set forth in claim 6, wherein a cross linking agent is contained in the primer layer.

10. The decorative film-like material as set forth in claim 6, wherein a cross linking agent is contained in the primer layer.

11. Automobile parts wherein a decorative film-like material set forth in claim 10 is bonded.

12. An automobile on whose surface a cosmetic coating is bonded via a bond; the cosmetic coating is composed of a decorative film-like material having at least a primer layer and a resin layer cured by heat or radiation formed by curing after coating in such a way as to cover a surface of the primer layer; and a primer layer of the cosmetic coating and the bond are united and integrated with an isocyanate cross linking agent contained in the bond reacted with a functional group of a molecular chain of a resin contained in the primer layer.

13. A bonding method of a decorative film-like material to automobile parts, wherein the decorative film-like material having at least a primer layer bonded to automobile parts and a resin layer cured by heat or radiation is formed in such a way as to be cured after coated on the primer layer and the decorative film-like material contains at least either of vinyl chloride vinyl acetate polymer resin or acrylic resin and an isocyanate cross linking agent in the primer layer.

14. A decorative sheet having at least a primer layer, a resin layer cured by heat and radiation formed by curing after coating on the primer layer, an adhesive layer formed on a surface in a primer layer side, and a releasing sheet for protecting an adhering layer, wherein the decorative sheet has a functional group in a molecular chain of a resin used in the primer layer to which a cross kinking agent reacts and the decorative sheet contains a cross kinking agent between layers of the premier layer and adhesive layer.

15. The decorative sheet as set forth in claim 14, wherein a functional group of a molecular chain of a resin used in the primer layer is at least either carboxyl group or hydroxyl group.

16. The decorative sheet as set forth in claim 15, wherein a resin used in the primer layer contains at least one component selected from the group consisting of polyester resin, alkyd resin, amino resin, acrylic resin, epoxy resin, and vinyl chloride resin.

17. The decorative sheet as set forth in claim 16, wherein the primer layer contains vinyl chloride vinyl acetate polymer resin or acrylic resin in a total of not less than 25% by weight.

18. The decorative film-like material as set forth in claim 17, wherein the cross linking agent is an isocyanate cross linking agent.

19. The decorative sheet as set forth in claim 18, having a metal thin film layer as a decorative layer and the like, between the primer layer and a resin layer cured by heat or radiation.

20. The decorative sheet as set forth in claim 18, wherein the primer layer has a releasing property to a releasing surface transcribed by a releasing sheet for printing.

21. Automobile parts adhered by a decorative sheet set forth in claim 18.

22. An adhesive method of a decorative sheet to automobile parts, wherein the decorative sheet having at least a primer layer adhered to automobile parts and a resin layer cured by heat or radiation is formed in such a way as to be cured after coated on the primer layer and the decorative sheet contains at least either of vinyl chloride vinyl acetate polymer resin or acrylic resin and the decorative sheet contains a cross linked resin cross linked by an isocyanate cross linking agent between the primer layer and an adhesive layer.
